(19) United States
(12) Patent Application Publication
(10) Pub. No.: US 2026/0260969 A1
(43) Pub. Date: Sep. 3, 2026

(54) Battery Assembly

(71) Applicant: SK On Co., Ltd., Seoul (KR)

(72) Inventors: Hyo Seong AN, Daejeon (KR); Gang U LEE, Daejeon (KR); Yu Bin KANG, Daejeon (KR); Jin Woo SON, Daejeon (KR); Chae Won NA, Daejeon (KR); Won Gab HWANG, Daejeon (KR)

(21) Appl. No.: 19/549,137

(22) Filed: Feb. 25, 2026

(30) Foreign Application Priority Data
Feb. 28, 2025 (KR) 10-2025-0026798

(51) Int. Cl. H01M 10/658; H01M 50/178; H01M 50/211; H01M 50/507

(52) U.S. Cl. CPC H01M 10/658; H01M 50/178; H01M 50/211; H01M 50/507; H01M 2200/10

(57) ABSTRACT

The present disclosure relates to a battery assembly including: a plurality of battery cells stacked in a stacking direction; an accommodation case configured to accommodate the plurality of battery cells; a insertion space defined between the plurality of battery cells and the accommodation case; and a refractory assembly including a refractory member including a refractory material and an exterior member configured to define a refractory space that accommodates the refractory member therein, the refractory assembly being disposed in the insertion space. Here, a volume of the refractory member relative to a volume of the refractory space is equal to or greater than 48% and equal to or less than 100%.

### CROSS-REFERENCE TO RELATED PATENT APPLICATION

The present application claims priority under 35 U.S.C. § 119(a) to Korean patent application number 10-2025-0026798 filed on Feb. 28, 2025, in the Ministry of Intellectual Property, the entire disclosure of which is incorporated by reference herein.

### BACKGROUND OF THE INVENTION

### 1. Field

The present disclosure relates to a battery assembly. More particularly, the present disclosure relates to a battery assembly with improved thermal stability.

### 2. Description of the Related Art

Due to recent fires and explosions that have occurred when lithium rechargeable batteries are used, social concerns about the safety of battery use are increasing. Based on these social concerns, one of the major development tasks of lithium secondary batteries in recent years is to eliminate unsafe conditions such as fire and explosion due to thermal runaway of battery cells.

In particular, there is an empty space in the battery module/pack other than the battery cell, which is the energy source. When a fire occurs due to an external impact or a problem with the battery cells, flames may spread to neighboring cells through the empty space, causing significant damage. The risk of such fires may be one of the biggest obstacles to the electric vehicle market, so devising a method to reduce the propagation of fire is an ongoing research.

### SUMMARY OF THE INVENTION

First, according to an aspect of the present disclosure, an object of the present disclosure is to mitigate or prevent thermal propagation (TP) of hot gases from one or more battery cells in a battery assembly, such as a battery module or battery pack, to neighboring battery cells after a thermal runaway occurs in one or more of the battery cells.

Second, according to another aspect of the present disclosure, an object of the present disclosure is to vent hot gases generated from a battery cell in which a thermal runaway occurs through an intended path.

Third, according to another aspect of the present disclosure, an object of the present disclosure is to increase the thermal stability of the battery assembly by increasing heat resistance or fire resistance thereof.

The battery assembly according to the present disclosure may be widely applied in electric vehicles, battery charging stations, and other green technology applications such as solar and wind power generation utilizing batteries. In addition, the battery assembly according to the present disclosure may be used in eco-friendly electric vehicles, and hybrid vehicles to prevent climate change by suppressing air pollution and greenhouse gas emissions.

Embodiments of the present disclosure provide a battery assembly including: a plurality of battery cells stacked in a stacking direction; an accommodation case configured to accommodate the plurality of battery cells; an insertion space defined between the plurality of battery cells and the accommodation case; and a refractory assembly including a refractory member including a refractory material and an exterior member configured to define a refractory space that accommodates the refractory member therein, the refractory assembly being disposed in the insertion space. Here, a volume of the refractory member relative to a volume of the refractory space is equal to or greater than 48% and equal to or less than 100%.

In an embodiment, each of the plurality of battery cells may include: a main body configured to accommodate an electrode assembly; and a lead tab having at least a portion disposed at the outside of the main body and electrically connected to the electrode assembly, and the insertion space may be separated into a separated spaces by respective lead tabs of the plurality of battery cells.

In an embodiment, the refractory assembly may be provided in plurality, and each of the plurality of refractory assemblies may be disposed in at least some of the plurality of separated spaces.

In an embodiment, the battery assembly may further include a busbar assembly electrically connected to the respective lead tabs and configured to support the plurality of battery cells, and the insertion space may be defined between respective main bodies of the plurality of battery cells and the busbar assembly.

In an embodiment, the busbar assembly may further include: a busbar electrically connected to the plurality of battery cells; and a busbar frame which is disposed between the busbar and the plurality of battery cells to support the busbar and into which respective lead tabs of the plurality of battery cells are inserted, respectively.

In an embodiment, the plurality of separated spaces may be defined by the busbar frame, respective main bodies, and respective lead tabs.

In an embodiment, a volume of the refractory assembly relative to a volume of any one of the plurality of separated spaces may be equal to or greater than 77% and equal to or less than 100%.

In an embodiment, the insertion space may include: a first insertion space defined between the plurality of battery cells and one side surface of the accommodation case, which extends along the stacking direction; and a second insertion space defined between the plurality of battery cells and the other side surface of the accommodation case, which faces the one side surface of the accommodation case, and the refractory assembly may be disposed in at least one of the first insertion space or the second insertion space.

In an embodiment, each of the lead tabs may include: a first lead tab configured to separate the first insertion space; and a second lead tab configured to separate the second insertion space, and the first insertion space and the second insertion space may be separated into a plurality of separated spaces by the first lead tap and the second lead tap, respectively.

In an embodiment, the exterior member may begin to melt when a predetermined temperature is reached.

In an embodiment, the predetermined temperature may be lower than a melting point of the refractory member.

In an embodiment, the refractory member may include silicon dioxide (SiO₂).

In an embodiment, at least one end of both ends of the exterior member may be tapered.

In an embodiment, the exterior member may include: a body having a columnar shape; and a first end and a second end connected to upper and lower ends of the body along a height direction of the accommodation case to define the refractory space with the body, and the first end may be gradually tapered in a direction away from the body.

In an embodiment, the accommodation case may further include a body bottom surface that is a bottom surface of the accommodation space, and the second end may include a flat surface parallel to the body bottom surface.

In an embodiment, the refractory member may include a plurality of refractory particles.

In an embodiment, the refractory member may further include a plurality of air gaps between the plurality of refractory particles.

In an embodiment, each of the plurality of refractory particles may be in the form of a granular material.

### BRIEF DESCRIPTION OF THE DRAWINGS

FIG. 1 is a view illustrating an example of a battery assembly according to the present disclosure.

FIG. 2 is a view illustrating an example of the battery assembly according to the present disclosure.

FIG. 3 is a top view illustrating the battery assembly according to the present disclosure.

FIG. 4 is a top view illustrating an example of a refractory assembly accommodated in an insertion space.

FIG. 5 is a side view illustrating the battery assembly according to the present disclosure.

FIG. 6A is a view illustrating an example of the refractory assembly accommodated in the insertion space.

FIG. 6B is a view illustrating one cross-section of the refractory assembly of FIG. 6A.

FIG. 7 is a schematic view illustrating refractory particles that are an example of a refractory member stacked in an insertion space after an exterior member is melted.

FIG. 8A is a view illustrating a portion of another example of the battery assembly according to the present disclosure.

FIG. 8B is a view illustrating a portion of another example of the battery assembly according to the present disclosure.

### DETAILED DESCRIPTION

Hereinafter, the present disclosure will be described in detail with reference to the accompanying drawings. However, this is merely an example, and the present disclosure is not limited to the specific embodiments described herein.

A battery assembly 200 according to the present disclosure is a generic term for a battery module or a battery pack. Thus, the battery assembly 200 according to the present disclosure may refer not only to the battery module, but also to a battery pack or an energy storage system (ESS) that accommodates battery cells without a battery assembly, such as a cell to pack (CTP).

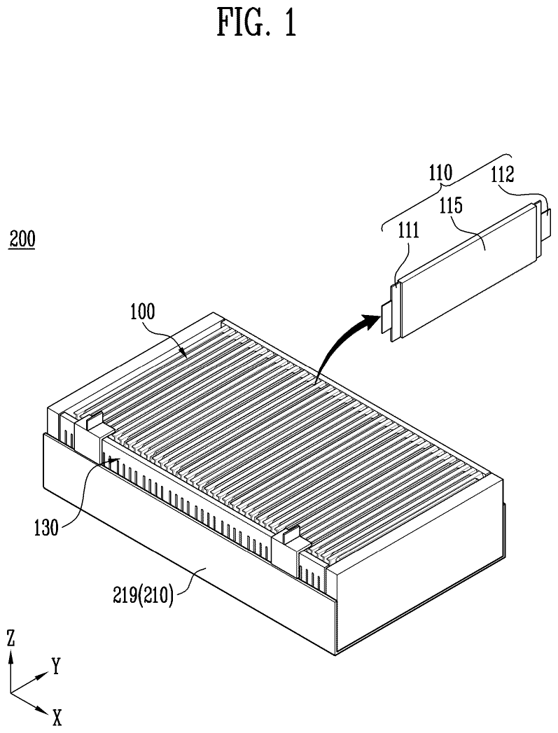

FIG. 1 is a view illustrating an example of the battery assembly 200 according to the present disclosure.

Referring to FIG. 1, the battery assembly 200 may include a plurality of battery cells 110, a busbar assembly 130 that electrically connects and supports the plurality of battery cells 110, and an accommodation case 210 that accommodates the plurality of battery cells 110.

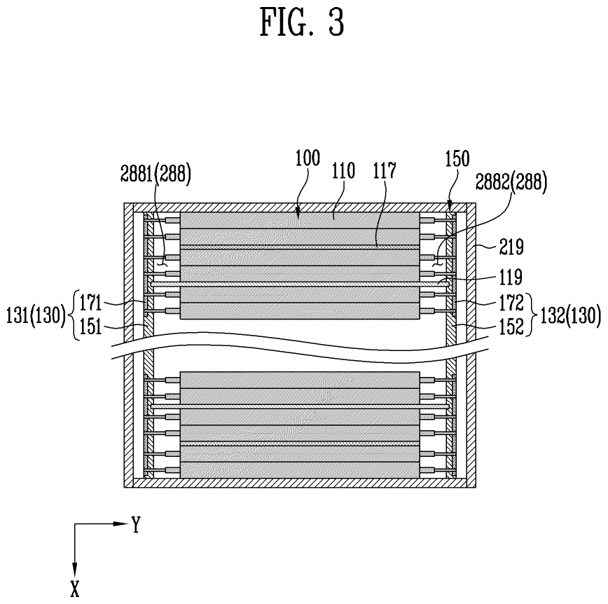

Each of the plurality of battery cells 110 may include a main body 115 for producing or storing electrical energy and lead tabs 111 and 112 protruding from the main body 115 to the outside of the main body 115. The main body 115 may include an electrode assembly (not shown) including a positive electrode and a negative electrode therein for producing and storing electrical energy. The main body 115 may accommodate the electrode assembly, and the lead tabs 111 and 112 may include at least a portion disposed at the outside of the main body 115 and electrically connected to the electrode assembly. An insertion space (see FIG. 3) may be separated into a plurality of spaces by respective lead tabs of the plurality of battery cells.

Also, the main body 115 may further include an electrolyte (not shown) that is in contact with the electrode assembly. The electrolyte may be liquid or solid. Also, when the electrolyte is liquid, the electrode assembly may further include a separator for separating the positive electrode from the negative electrode. Referring to FIG. 1, the main body 115 may have a pouch shape sealed with a film-type exterior member.

Although an example of the pouch-shaped battery cell 110 is illustrated in FIG. 1, the embodiment of the present disclosure is not limited thereto. For example, the battery cell 110 may have a rectangular or cylindrical shape.

Specifically, the lead tabs 111 and 112 may include a first lead tab 111 and a second lead tab 112, which respectively protruding from two side surfaces of the main body 115 in a direction away from the main body 115. Alternatively, the lead tabs 111 and 112 may protrude in the same direction.

On the other hand, the accommodation case 210 is intended to protect the plurality of battery cells 110 from external shocks, such as vibration. The accommodation case 210 may include an accommodation body 219 that forms a portion of an accommodation space 280 that accommodates the plurality of battery cells 110, which will be described later.

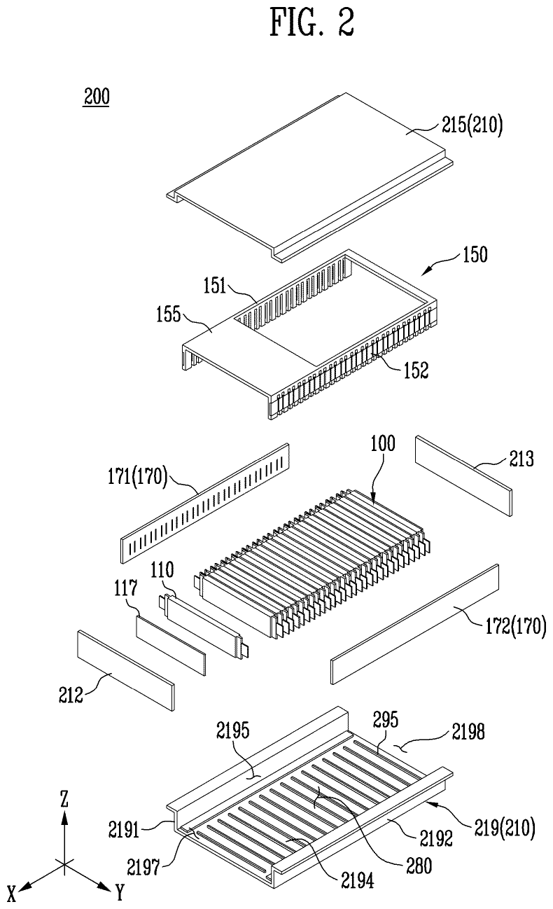

The busbar assembly 130 may further include a busbar 170 (refer to FIG. 2) electrically connected to the plurality of battery cells 110 and a busbar frame 150 (refer to FIG. 2) which is disposed between the busbar 170 and the plurality of battery cells 110 to support the busbar 170 and into which the respective lead tabs 111 and 112 of the plurality of battery cells 110 are inserted.

The busbar assembly 130 or the busbar 170 assembled with the plurality of battery cells 110 may be referred to as a cell stack 100.

FIG. 2 is an exploded view illustrating the battery assembly 200 according to the present disclosure.

Referring to FIG. 2, the accommodation case 210 may include an accommodation body 219 that forms a portion of an accommodation space 280 for accommodating the cell stack 100 and an accommodation cover 215 that is coupled to the accommodation body 219 to form the accommodation space 280 together.

The plurality of battery cells 110 may be arranged to overlap each other along a predetermined stacking direction (e.g., X-direction) inside the accommodation body 219.

More specifically, the accommodation case 210 may further include an accommodation body 219 having an opened top surface 2195 and accommodating the plurality of battery cells 110 through the opened top surface 2195 and an accommodation cover 215 coupled to the accommodation body 219 to close the opened top surface 2195.

Thus, the accommodation cover 215 may be coupled to the accommodation body 219 to form a top surface of the accommodation space 280 or a top surface of the accommodation case 210. That is, the accommodation cover 211 may be coupled to the accommodation body 219 to close the opened top surface 2195, and may form the accommodation space 280 together with the accommodation body 219.

The accommodation space 280 may not only accommodate the cellular stack 100, but also form a portion of the accommodation space 280 as an insertion space 288 that will be described later.

On the other hand, the accommodation body 219 may have a channel shape or U shape with an opened upper portion. Referring to FIG. 2, both side surfaces 2197 and 2198 of the accommodation body 219, which face each other in the X-direction, may also be opened.

That is, the accommodation body 219 may include a body bottom surface 2194 forming a bottom surface of the accommodation space 280 and body side surfaces 2191 and 2192 extending toward the accommodation cover 211 from edges (not shown) parallel to each other in the staking direction among edges of the body bottom surface 2195. Free ends of the body side surfaces 2191 and 2192 may be bent to form a flange (not shown). This is to facilitate engagement with the accommodation cover 211.

Referring to FIGS. 1 and 2, the accommodation body 219 may have a height less than that of each of the plurality of battery cells 110. However, this is merely an example, and the accommodation body 219 may have a height equal to or greater than that of each of the plurality of battery cells 110.

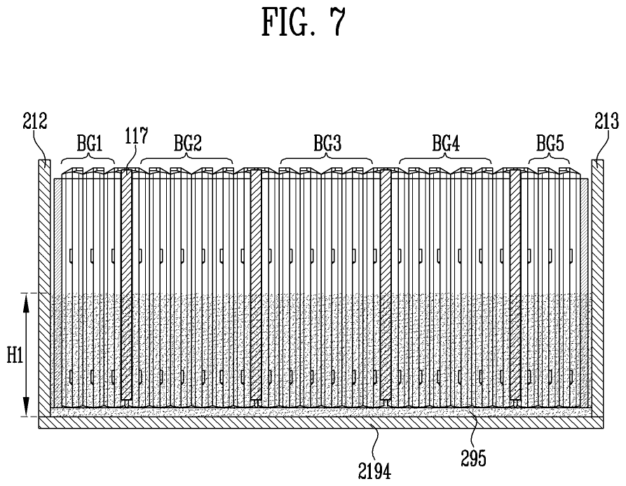

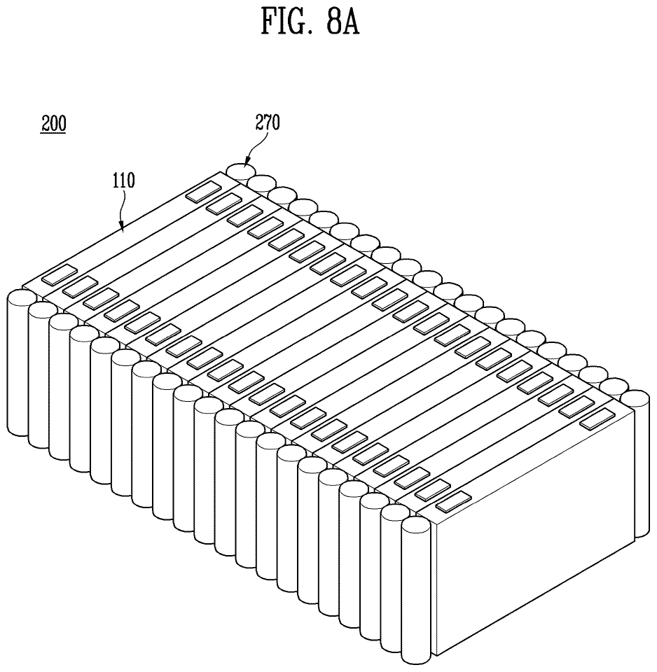

The cell stack 100 may further include a buffer member 117 or a thermal barrier member 119 (refer to FIG. 3) disposed between the plurality of battery cells 110. The buffer member 117 may be disposed between each of the plurality of battery cells 110, or may be disposed between battery groups BG1 to BG5 (refer to FIG. 7) grouping the plurality of battery cells 110. The same applied to the thermal barrier member 119.

The thermal barrier member 119 may act as a thermal barrier to prevent flame or heat from propagating to other neighboring battery cells 110 in the event of a thermal runaway of one battery cell 110.

The cell stack 100 may include at least one of the buffer members 117. Similarly, the cellular laminate 100 may include at least one or more of the thermal barrier members 119. Alternatively, the thermal barrier member 119 may simultaneously perform a thermal barrier function and a buffering function.

To this end, the thermal barrier member 119 may also be formed as a multilayer structure along the stacking direction of the plurality of battery cells 110. That is, one layer of the multilayer structure may be made of a flame retardant material (or a refractory material). Also, another layer of the multilayer structure may serve to reduce pressure applied to the other battery cells 110 upon swelling of the battery cells 110.

The plurality of battery cells 110 and the plurality of thermal barrier members 119 may be disposed between the plurality of battery cells 110. The thermal barrier members 119 may be made of a refractory (heat-resistant or flame-retardant) material. For example, the thermal barrier member 119 may include a refractory polymer or a material such as mica.

Referring to FIG. 2, the battery assembly 200 may further include end plates 212 and 213 at both ends of the cell stack 100 along the stacking direction. The end plates 212 and 213 may be disposed at both ends of the cell stack 100 and connected to both side surfaces 2197 and 2198 of the accommodation body 219. The end plates 212 and 213 are intended to prevent both side surfaces of the cell stack 100 from being exposed to the outside.

Thus, the end plates 212 and 213 may be disposed on the outermost sides of the plurality of battery cells 110 along the stacking direction (X direction) of the plurality of battery cells.

On the other hand, the battery assembly 200 may include the busbar 170 electrically connected to the plurality of battery cells 110. Also, the battery assembly 200 may further include the busbar frame 150 supporting the busbar 170 and the plurality of battery cells 110. As described above, the busbar 170 and the busbar frame 150 may be collectively referred to as the busbar assembly 130.

The busbar assembly 130 may include a first busbar frame 151 and a second busbar frame 152, which are spaced apart from each other with the plurality of battery cells 110 therebetween and extend along the stacking direction of the plurality of battery cells 110.

Also, the busbar assembly 130 may further include a support frame 155 disposed on one side of the busbar assembly 130 to connect the first busbar frame 151 and the second busbar frame 152 to each other.

The busbar assembly 130 is described by using a case in which the lead tabs 111 and 112 are disposed on opposite sides of the main body 115, respectively. Alternatively, when the lead tabs 111 and 112 are at one side of the main body 115 and face the same direction, the busbar frame 150 may be disposed at one side of the main body 115 (e.g., above the main body 115) and electrically connected to the lead tabs 111 and 112.

The support frame 155 may serve to support the first busbar frame 151 and the second busbar frame 152 and prevent the first busbar frame 151 and the second busbar frame 152 from being deformed. Also, a portion of an electrical apparatus for sensing and controlling the plurality of battery cells 110 may be disposed on the support frame 155.

Referring to FIG. 2, the busbar assembly 130 may have a tunnel shape. Also, in the stacking direction, each of the first busbar frame 151 and the second busbar frame 152 may have a length greater than that of the support frame 155.

In other words, the support frame 155 may be connected with the first busbar frame 151 and the second busbar frame 152 to cover an upper portion of the plurality of battery cells 110. That is, the support frame 155 may cover all of the upper portion of the plurality of battery cells 110 instead of covering only a portion of the upper portion of the plurality of battery cells 110.

Referring to FIG. 2, the busbar 170 may include a first busbar 171 supported by the first busbar frame 151 and electrically connected to the first lead tab 111 and a second busbar 172 supported by the second busbar frame 152 and electrically connected to the second lead tab 112.

The first busbar 171 and the second busbar 172 may be disposed in a direction farther away from the plurality of battery cells 110 than the first busbar frame 151 and the second busbar frame 152, respectively.

That is, the first busbar 171 may be disposed between the plurality of battery cells 110 and the first busbar frame 151, and the second busbar 172 may be disposed between the plurality of battery cells 110 and the second busbar frame 152.

Referring to FIG. 2, the first busbar 171 may contact an outer side of the first busbar frame 151, and the second busbar 172 may contact an outer side of the second busbar frame 152. That is, the first busbar 171 and the second busbar 172 may be disposed closer to the body side surfaces 2191 and 2192 than the first busbar frame 151 and the second busbar frame 152, respectively. Accordingly, the first lead tab 111 and the second lead tab 112 may be inserted into slit holes (not shown) defined in the first busbar frame 151 and the second busbar frame 152, respectively, and electrically connected to the first busbar 171 and the second busbar 172, respectively. However, this is merely an example, and the first lead tab 111 and the second lead tab 112 may be electrically connected to the first busbar 171 and the second busbar 172, respectively, in other manners.

Also, the battery assembly 200 may further include a heat dissipation part 295 disposed between the body bottom surface 2194 and the plurality of battery cells 110 for transferring heat generated by the plurality of battery cells 110 to the outside of the battery assembly 200.

The heat dissipation part 295 may be provided in the form of an adhesive material having thermal conductivity, e.g., a thermally conductive adhesive. Accordingly, the plurality of battery cells 110 may be adhered to the body bottom surface 2194 through the heat dissipation part 295.

To this end, the heat dissipation part 295 may be sprayed or applied onto the body bottom surface 2194.

FIG. 3 is a top view illustrating the battery assembly 200 according to the present disclosure.

The busbar assembly 130 may include a first busbar 171 electrically connected to the first lead tab 111 and a first busbar frame 151 supporting the first busbar 171. The first busbar 171 and the first busbar frame 151 may collectively be referred to as a first busbar assembly 131. That is, the first busbar assembly 131 may be electrically connected to the first lead tap 111 and may serve to support the cell stack 100.

The busbar assembly 130 may further include a second busbar 172 electrically connected to the second lead tap 112 and a second busbar frame 152 supporting the second busbar 172. The second busbar 172 and the second busbar frame 152 may collectively be referred to as a second busbar assembly 132. That is, the second busbar assembly 132 may be electrically connected to the second lead tap 112 and may serve to support the cell stack 100 together with the first busbar assembly 131.

Referring to FIG. 3, due to the electrical connection between the lead tabs 111 and 112 and the busbar assembly 130, an empty space (hereinafter, referred to as an insertion space 288) may be defined between the plurality of battery cells 110 and the busbar assembly 130.

That is, a portion of the accommodation space 280 formed inside the accommodation case 210 may be a space for accommodating the plurality of battery cells 110, and another portion of the accommodation space 280 may be a space for the insertion space 288.

That is, the insertion space 288 may be defined between the plurality of battery cells 110 and the accommodation case 210. More specifically, the insertion space 288 is a space defined by each main body 115 of the plurality of battery cells 110, each lead tab 111 and 112 of the plurality of battery cells 110, and the busbar 170. In a typical case, when a thermal runaway occurs in any one of the plurality of battery cells 110, and off-gassing occurs, high temperature heat may propagate to other neighboring battery cells through the insertion space 288. In order to prevent such thermal propagation (TP), it is necessary to fill the insertion space 288 with another refractory (flame-retardant or heat-resistant) material.

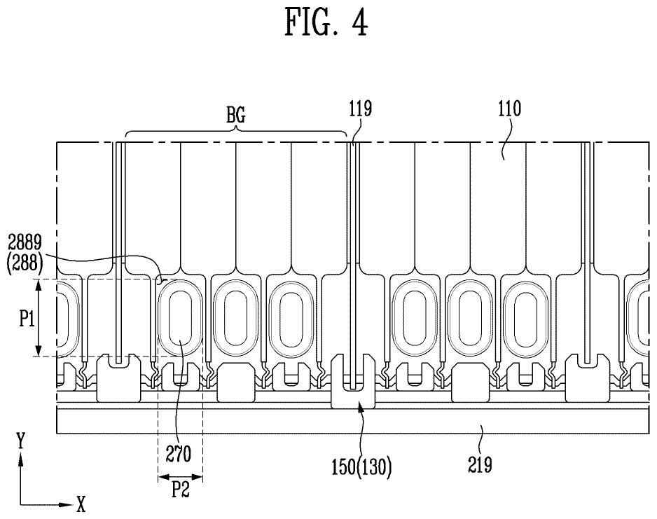

To this end, the battery assembly 200 according to the present disclosure may include a refractory assembly 270 (refer to FIG. 4) inserted and disposed in the insertion space 288.

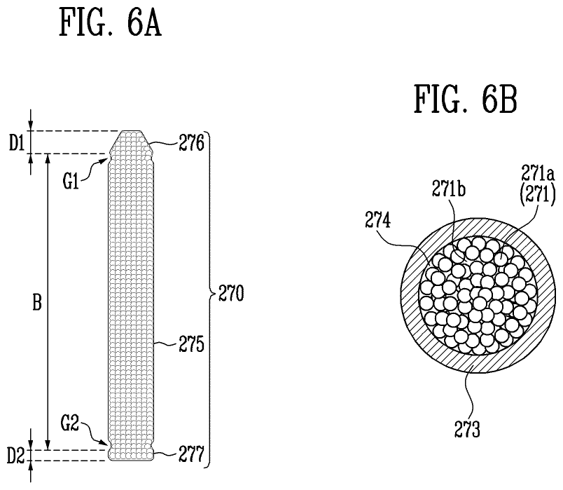

In other words, the battery assembly 200 according to the present disclosure includes a plurality of battery cells 110 stacked in a predetermined stacking direction, an accommodation case 210 accommodating the plurality of battery cells 110, an insertion space 288 defined between the plurality of battery cells 110 and the accommodation case 210, and a refractory assembly 270 (refer to FIG. 4) including a refractory member 271 including a refractory material and an exterior member 273 defining a refractory space 274 (refer to FIG. 6B) accommodating the refractory member 271 therein, and disposed in the insertion space 288.

Also, a volume of the refractory member 271 relative to a volume of the refractory space 274 may be at least 48% and no more than 100%. Specifically, the volume of the refractory member 271 relative to the volume of the refractory space 274 may be equal to or greater than 65% and equal to or less than 100%, or equal to or greater than 88% and equal to or less than 100%. A description related to numerical ranges will be described later using Table 1.

Referring now to FIG. 3, the buffer member 117 or the thermal barrier member 119 may be disposed between the plurality of battery cells 110. The buffer member 117 or the thermal barrier member 119 may be provided between each of the plurality of battery cells 110. Alternatively, the buffer member 117 or the thermal barrier member 119 may be disposed between battery groups BG1 to BG5 grouping neighboring battery cells 110 into a predetermined number of groups.

The battery groups BG1 to BG5 refers to a set of battery cells 110 in which neighboring battery cells 110 of the plurality of battery cells 110 are grouped into a predetermined number of groups. After grouping the plurality of battery cells 110 into the number of groups for a predetermined target voltage or target current, the battery groups BG1 to BG5 may be connected in series or in parallel using the busbar 170.

On the other hand, along a direction from the first busbar frame 151 towards the second busbar frame 152, the length of thermal barrier member 119 may have a length greater than that of the main body 115. More specifically, the thermal barrier member 119 may contact the first busbar assembly 131 and the second busbar assembly 132. This may allow the thermal insulation member 119 to block or mitigate propagation of heat or flame to other locations when thermal runaway occurs in any one of the battery cells 110.

The insertion space 288 may include a first insertion space 2881 defined between the plurality of battery cells 110 and one side surface of the accommodation case 210 extending along the stacking direction and a second insertion space 2882 defined between the plurality of battery cells 110 and the other side surface of the accommodation case 210 facing the one side surface, and the refractory assembly 270 may be disposed in at least one of the first insertion space 2881 or the second insertion space 2882.

Also, the first insertion space 2881 may be spatially separated by the first lead tab 111. In addition, the second insertion space 2882 may be spatially separated by the second lead tap 112. However, when the cell stack 100 is accommodated in the accommodation body 219, since a length of each of the first lead tab 111 and the second lead tab 112 in a height direction of the accommodation case 110 or the accommodation body 219 is less than a height of the battery cell 110, the first insertion space 2881 and the second insertion space 2882 may communicate with each other.

Also, the first insertion space 2881 and the second insertion space 2882 may communicate with each other through a space between the plurality of battery cells 110 and the accommodation cover 215. Thus, the first insertion space 2881 and the second insertion space 2882 may be spaces that are communicable with each other instead of being separated and isolated from each other.

FIG. 4 is a top view illustrating an example of the refractory assembly 270 accommodated in the insertion space 288.

The insertion space 288 may be formed between each main body 115 of the plurality of battery cells 110 and the busbar assembly 130. The busbar assembly 130 may be electrically connected to the respective lead tabs 111 and 112, and support the plurality of battery cells 110.

The insertion space 288 may be formed as each lead tab 111 and 112 is connected to the busbar assembly 130 (or the busbar frame 150).

Also, the insertion space 288 may be divided into a plurality of separated spaces 2889 by each lead tab 111 and 112 of the plurality of battery cells 110.

Also, the refractory assembly 270 may be provided in plurality, and each of the plurality of refractory assemblies 270 may be disposed in at least some of the plurality of separated spaces 2889.

More specifically, each of the plurality of separated spaces 2889 may be defined by the busbar frame 150, each of the main bodies 115, and each of the lead tabs 111 and 112.

That is, the lead tabs 111 and 112 may include a first lead tab 111 defining a first insertion space 2881 and a second lead tab 112 defining a second insertion space 2882, and the first insertion space 2881 and the second insertion space 2882 may be divided into a plurality of separated spaces 2889 by the first lead tab 111 and the second lead tab 112, respectively.

Each of the lead tabs 111 and 112 does not isolate each of the plurality of separated spaces 2889. That is, since a length of each of the lead tabs 111 and 112 along the height direction of the accommodation case 210 is less than a height of the accommodation space 280, only at least a portion of the accommodation space 280 may be separated along the height of the accommodation space 280.

That is, since a length of each of the lead tabs 111 and 112 along the height direction of the accommodation case 210 is less than that of each of the main bodies 115, the plurality of separated spaces 2889 may be separated by each lead tab 111 and 112 and may communicate with each other.

Thus, as described above, the plurality of separated spaces 2889 may communicate with each other. Also, the refractory assembly 270 may also be provided in plurality, and a plurality of refractory assemblies 270 may be inserted into the plurality of separated spaces 2889, respectively.

Referring to FIG. 4, the battery assembly 200 may further include a thermal barrier member 119 disposed between the plurality of battery cells 110. Alternatively, the battery assembly 200 may further include a thermal barrier member 119 disposed between the battery groups BG grouping the plurality of battery cells 110.

Referring to FIG. 4, the thermal barrier member 119 may be provided in parallel to the plurality of battery cells 110 and extend to the busbar assembly 130. More specifically, the thermal barrier member 119 may extend to the busbar frame 150 and may be inserted into the busbar frame 150. In this case, the refractory assembly 270 may not be inserted into the space into which the thermal barrier member 119 is inserted. This is to prevent interference between the refractory assembly 270 and the thermal barrier member 119.

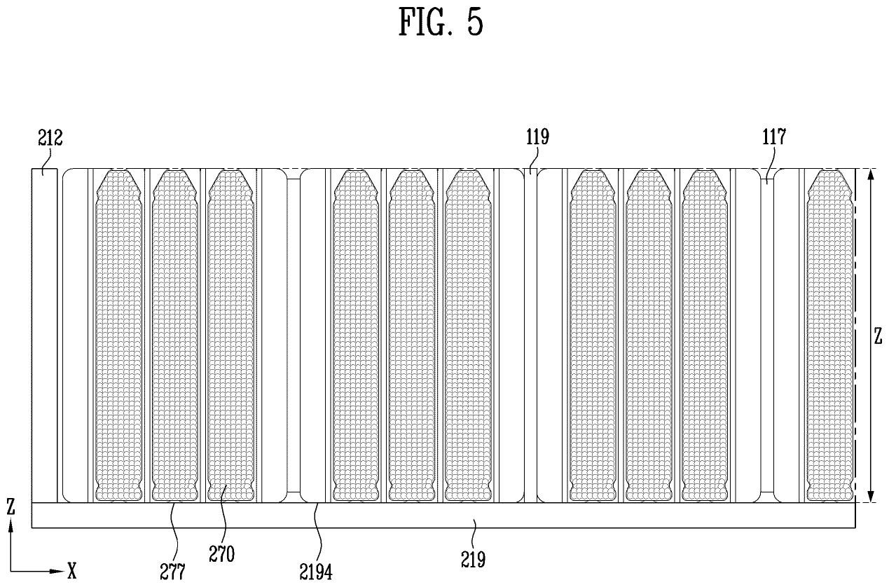

Referring to FIG. 4, a size of any one of the plurality of separated spaces 2889 may be determined by P1, P2, and P3 (refer to FIG. 5) that will be described later. That is, a volume of any one of the separated spaces 2889 may be calculated by P1, P2, and P3. Here, P1 is a length from one end of the main body 115 to the busbar frame 150 in the Y direction, P2 is a length between adjacent lead tabs 111 and 112 in the X direction, and P3 is a height of the accommodation space 280 (or a length from the body bottom surface 2194 to the accommodation cover 215).

FIG. 5 is a side view illustrating the battery assembly according to the present disclosure.

Specifically, with reference to FIGS. 2 and 5, FIG. 5 illustrates a region adjacent to one of two end plates 212 and 213 when viewing the battery assembly 200 after removing the body side surfaces 2191 and 2192 and the busbar assembly 130.

Referring to FIGS. 1, 2, and 5, the insertion space 288 is separated into a plurality of separated spaces 2889 by respective lead tabs 111 and 112 disposed on the outer sides of the plurality of battery cells 110 and connecting the busbar 170 to the plurality of battery cells 110, and the refractory assembly 270 may be provided in plurality and inserted into at least some of the plurality of separated spaces 2889.

Although FIG. 5 illustrates an example in which the plurality of refractory assemblies 270 are inserted into the plurality of separated spaces 2889 in a one-to-one corresponding manner, the plurality of refractory assemblies 270 may be disposed in only some of the plurality of separated spaces 2889. That is, when the refractory assemblies 270 may mitigate thermal runaway of the battery cell 110, the refractory assemblies 270 may not necessarily be disposed in all of the plurality of separated spaces 2889.

Referring to FIG. 5, a length of the battery cell 110 (refer to FIG. 1) along a height direction of the accommodation case 210 may be equal to or greater than that of the refractory assembly 270. Preferably, a length of the refractory assembly 270 may be equal to or greater than 50% and equal to or less than 100% of the length of the battery cell 110.

Referring to FIG. 5, the plurality of refractory assemblies 270 may have different filling rates of the refractory member 271 filled in respective exterior members 273. This is in consideration of locations in the battery assembly 200 at which thermal runaway is more likely to occur. That is, among the plurality of refractory assemblies 270, a filling rate of the refractory member 271 filled in one refractory assembly 270 disposed at a middle portion of the accommodation case 210 may be different from that of the refractory member 271 filled in another refractory assembly 270 disposed at a side portion of the accommodation case 210.

Referring to FIGS. 2 and 5, the accommodation case 210 may further include an accommodation body 219 having an opened top surface 2195 and accommodating the plurality of battery cells 110 through the opened top surface 2195 and an accommodation cover 215 coupled to the accommodation body 219 to cover the opened top surface 2195.

Referring to FIG. 5, a height from the body bottom surface 2194 to an upper end of the battery cell 110 is referred to as P3.

FIG. 6A is a view illustrating an example of the refractory assembly 270 accommodated in the insertion space 288. FIG. 6B is a view illustrating a cross-section of the refractory assembly 270 in FIG. 6A.

Referring to FIGS. 6A and 6B, the refractory assembly 270 may include a column-shaped exterior member 273 accommodating a bead-shaped refractory member 271 including a refractory material and extending along a height direction of the accommodation case 210. In consideration of functions and shapes of the refractory member 271 and the exterior member 273, the refractory assembly 270 may be referred to as a refractory capsule or an FR capsule.

Referring to FIG. 6B, the refractory member 271 may comprises a plurality of refractory particles 271a.

A rate at which the refractory member 271 is filled into the exterior member 273 may vary depending on a use environment. That is, the filling rate of the refractory member 271 may vary in consideration of a position at which the refractory assembly 270 is located in the accommodation case 210. The filling rate may refer to a percentage of a volume occupied by the refractory member 271 relative to an internal volume of the exterior member 273.

Referring to FIGS. 6A and 6B, although the refractory member 271 is illustrated as completely filling the refractory space 274 along a height direction of the exterior member 273, when the refractory member 271 fills 30% or more of the insertion space 288, the refractory member 271 may mitigate thermal propagation from the battery cell 110. This is because, when the exterior member 273 melts at or above an allowable temperature, the refractory member 271 may move from the insertion space 288 to another location in accordance with a flow of flame or gas.

From a perspective of the refractory assembly 270, the refractory assembly 270 may fill 50% or more of the insertion space 288. This is because not only a volume occupied by the refractory member 271 but also a volume occupied by the exterior member 273 needs to be considered for the refractory assembly 270.

On the other hand, a height of the refractory assembly 270 along the height direction of the accommodation case 210 may be greater than a length (or diameter) of the refractory assembly 270 along the stacking direction. That is, the refractory assembly 270 may have a cylindrical shape formed by extending along the height direction of the accommodation case 210.

Also, in consideration of the size of the insertion space 288, the length (or diameter) of the refractory assembly 270 along the stacking direction may be equal to or less than the thickness of any one of the plurality of battery cells. This is to facilitate insertion of the refractory assembly 270 into the insertion space 288.

Preferably, the refractory assembly 270 may have a cylindrical shape. Thus, the length of the refractory assembly 270 along the stacking direction may refer to a diameter when the refractory assembly 270 has a circular cross-section.

On the other hand, at least one of the first end 276 or the second end 277 of the refractory assembly 270 or the exterior member 273 may be tapered.

This is to facilitate insertion of the refractory assembly 270 into the insertion space 288. That is, at least one end of the refractory assembly 270 may be tapered so that, when the refractory assembly 270 is inserted into the insertion space 288, the refractory assembly 270 may be guided into the insertion space 288.

Referring to FIG. 6B, the exterior member 273 may further include a refractory space 274 formed by the exterior member 273 to accommodate the refractory member 271 or the refractory particles 271a.

FIG. 6A illustrates an example in which the exterior member 273 has a cylindrical shape. However, the shape of the exterior member 273 is not limited thereto. The exterior member 273 may have any shape as long as the exterior member 273 is insertable into the insertion space 288.

In the drawings of this specification, the refractory member 271 is assumed to be spherical for convenience, but the shape of the refractory member 271 is not limited to a spherical shape. Accordingly, the refractory member 271 may have an amorphous shape. Also, the refractory member 271 is not limited to a single size, but may be provided in a form in which refractory members 271 of various sizes are mixed. in addition, the refractory member 271 is illustrated in an exaggerated size relative to an actual size for clarity of description.

Referring to FIGS. 5, and 6B, the refractory member 271 may include a plurality of refractory particles 271a. Also, the refractory member 271 may further include a plurality of air gaps 271b between the plurality of refractory particles 271a.

The refractory particles 271a may be solid fillers in the form of solid shaped particles, powders, granules, pellets, or beads. This is to prevent or retard flame propagation or thermal propagation through the insertion space 288 in the case of thermal runaway of any of the battery cells 110.

A size of each of the refractory particles 271a may preferably be equal to or greater than 2 μm (micrometers) and equal to or less than the length or thickness of one battery cell 110 along the stacking direction.

Preferably, the size of each of the refractory particles 271a may have a micro-size. The micro-sized refractory particles 271a may be referred to as micro-beads or micro-granulates.

A melting point of the refractory particles 271a may preferably be higher than a predetermined temperature (or allowable temperature) that will be described later. Preferably, the predetermined temperature may be equal to or greater than 50° C. degrees Celsius (° C.) and equal to or less than 300 degrees Celsius (° C.).

The exterior member 273 may begin to melt upon reaching the predetermined temperature. Thus, the melting point of the refractory member 271 or the refractory particles 271a may be higher than the predetermined temperature. In other words, the predetermined temperature may be lower than the melting point of the refractory member 271 or the refractory particles 271a.

Also, the melting point of the refractory particles 271a may be higher than an ignition point of the plurality of battery cells 110. The ignition point of the plurality of battery cells 110 may be the temperature at which venting occurs in the battery cells 110. Alternatively, when the exterior member (or accommodation case) of the battery cell 110 is torn or opened under a thermal runaway condition, the ignition point may be a temperature of the electrolyte accommodated in the battery cell 110, that is, in the main body 115.

Thus, when any one of the battery cells 110 begins to thermal runaway, the exterior member 273 may begin to melt, but the refractory particles 271a may remain in solid form. This is to prevent the refractory particles 271a from burning or melting.

For example, although the thermal runaway of the battery cell 110 occurs, the refractory particles 271a may not burn or melt and the appearance of the refractory particles 271a may remain unchanged.

The refractory member 271 or the refractory particles 271a may include a porous material. The porous material refers to a material including pores formed therein. The pores may have irregular and amorphous shapes. Specifically, when the refractory member 271 or the refractory particles 271a include silica gel in a particulate form or a powder form, a porosity of the refractory particles 271a may be 20 percent (%) or more and 30 percent (%) or less.

The refractory member 271 or the refractory particles 271a may be inserted into the refractory space 274 formed by the exterior member 273 and may be free to move. That is, the refractory member 271 or the refractory particles 271a may not be fixed or bonded to any other structure or component of the battery assembly 200. Simply, the refractory member 271 or the refractory particles 271a are disposed in the refractory space 274 and are in contact with each other without any constraint.

In other words, the refractory member 271 or the refractory particle 271a may be a solid filler. Also, the solid filler may be in the form of a plurality of granular materials or granules. That is, the plurality of refractory particles 271a may be in the form of granular materials.

When the exterior member 273 is melted, and the refractory member 271 or the refractory particles 271a accommodated in the refractory space 274 are exposed to the accommodation space 280, the plurality of pores may act to retard thermal propagation and disperse the flame in various paths other than straight lines.

Also, the plurality of pores 271b may act as an electrical insulation member or a thermal insulation member in high temperature, high humidity environments during thermal runaway.

In consideration that the refractory member 271 or the refractory particles 271a are made of a refractory material such as silica gel, alumina gel, or aerogel, the refractory particles 271a or the refractory member 271 may include silicon dioxide (SiO₂).

Referring to FIG. 6A, a length B of a body 275 may be longer than a length D1 of a first end 276 and a length D2 of a second end 277.

Also, the body 275 may have a cylindrical shape. The refractory assembly 270 may further include grooves G1 and G2 formed by inwardly recessing along a circumferential surface of the cylindrical body part 275. The grooves G1 and G2 may be formed between the first end 276 and the body 275, and between the second end 277 and the body 275. This is to prevent damage to the battery cell 110 adjacent to the refractory assembly 270 upon insertion of the refractory assembly 270. Also, the grooves G1 and G2 are intended to secure a fastening force between the first end 276 and the body 275 and between the second end 277 and the body 275.

Furthermore, the first end 276 may be gradually tapered in a direction away from the body 275.

That is, the exterior member 273 may include a columnar body 275, and a first end 276 and a second end 277 connected to the body 275 at upper and lower ends of the body 275 along a height direction of the accommodation case 210 to form the refractory space 274 with the body 275, and the first end 276 may be gradually tapered in a direction away from the body 275.

In contrast, the second end 277 may include a flat surface (plane) parallel to the body bottom surface 2194.

FIG. 7 is a schematic view illustrating refractory particles 271a (refer to FIG. 6b) that are an example of the refractory member 271 stacked the insertion space 288 after the exterior member 273 is melted.

Specifically, FIG. 7 illustrates an example in which the exterior member 273 is melted at a temperature above the allowable temperature, and the refractory particles 271a are separated into granules and filled in the insertion space 288 to a predetermined filling height H1 along the height direction of the accommodation case 210 or the accommodation body 219.

The insertion space 288 may be divided into a plurality of separated spaces 2889, and a plurality of refractory assemblies 270 may be inserted into at least some of the plurality of separated spaces 2889. A volume of each of the insertion spaces 288 may be greater than a sum of volumes of the refractory assemblies 270 inserted into the plurality of separated spaces 2889.

As a result, during thermal runaway of the plurality of battery cells 110, the refractory particles 271a may not fill the insertion spaces 288 to an upper end in the height direction of the battery cells 110, even assuming that all of the exterior members 273 are melted.

That is, assuming that the battery assembly 200 reaches the allowable temperature and all of the exterior members 273 are melted, the refractory particles 271a may fill the insertion space 288 up to the filling height H1 in the form of grains.

Referring to FIG. 7, the filling height may be a height denoted by H1 from the body bottom surface 2194, which is the bottom surface of the accommodation body 219.

For example, the filling height H1 in FIG. 7 illustrates an example of a height corresponding to when 50% of the volume of the insertion space 288 is filled with the refractory particles 271a after the exterior member 273 is melted.

The battery assembly 200 may further include a heat dissipation part 295 between the plurality of battery cells 110 and the body bottom surface 2194. The heat dissipation part 295 may be a material that is first applied as a liquid to the body bottom surface 2194 before the plurality of battery cells 110 are accommodated, and then cured after a predetermined elapsed time after the plurality of battery cells 110 are accommodated.

On the other hand, a thickness of the heat dissipation part 295 may be negligible compared to the height of the accommodation body 219 or the filling height H1.

Also, the battery assembly 200 may have end plates 212 and 213 disposed at both ends of the plurality of battery cells 110 along the stacking direction. In addition, the plurality of battery cells 110 may be grouped such that some adjacent battery cells 110 are grouped to form battery groups BG1 to BG5. The plurality of battery cells 110 in one battery group may be arranged with the same polarity and connected in parallel. Thus, each of the battery groups BG1 to BG5 may have a polarity arrangement different from that of an adjacent battery group BG1 to BG5.

Also, the battery assembly 200 may further include a thermal barrier member 119 (refer to FIG. 3) or a buffer member 117 between the plurality of battery groups BG1 to BG5.

When the exterior member 273 that restrains the refractory particles begins to melt, the refractory particles, which are an example of the refractory member 271, may move freely. Accordingly, due to a flow of flame or off-gas generated during thermal runaway, the refractory particles, which are an example of the refractory member 271, may be subjected to a force and move to another position.

As described above, since the plurality of insertion spaces 288 are in communication with each other, when flame propagates toward another battery cell 110 or off-gas moves (in an arrow direction) from the insertion space 288 corresponding to a battery cell 110 in which thermal runaway occurs, refractory particles may move from the insertion space 288 corresponding to the battery cell 110 in which thermal runaway occurs to another insertion space 288.

In other words, when the exterior member 273 is melted and refractory particles, which are an example of the refractory member 271, become freely movable in a granular form, the refractory particles may move, due to pressure generated when thermal runaway occurs in any one of the plurality of battery cells 110, to an insertion space 288 corresponding to a normally operating battery cell 110 in which thermal runaway does not occur.

Accordingly, when the exterior member 273 is melted, since the plurality of refractory particles 271a are movable to other locations in accordance with movement of flame or high-temperature gas, the refractory member 271 or the plurality of refractory particles 271a may not necessarily need to fill 100% of the plurality of separated spaces 2889 or the insertion space 288.

Hereinafter, embodiments of the present invention will be further described with reference to specific experimental examples. It will be apparent to those skilled in the art that various changes and modifications to the embodiments are possible within the scope and spirit of the present invention, and that such changes and modifications fall within the scope of the appended patent claims.

TABLE 1

| | Volume of refractory | Volume of refractory | Thermal |
|---|---|---|---|
| | member relative to volume | assembly relative to volume | propagation |
| | of refractory space | of separated space | rate (Wh/s) |
| Comparative | 0% | 0% | 122.57 |
| Example 1 | | | |
| Embodiment 1 | 48% | 77% | 73.83 |
| Embodiment 2 | 65% | 77% | 23.3 |
| Embodiment 3 | 88% | 77% | 17.98 |

Table 1 shows a thermal propagation rate (or an ultrashort heat transfer amount) according to a ratio of a volume of the refractory member 271 to a volume of the refractory space 274 in one refractory assembly 270.

Also, in Table 1, a ratio of a volume of the refractory assembly 270 to a volume of one separated space 2889, as described in a second column, represents a proportion of the volume of the refractory assembly 270 listed in a first column relative to the volume of the one separated space 2889.

Referring to Table 1, in the present disclosure, when the volume of the refractory member 271 relative to the volume of the refractory space 274 is 48% or more and 100% or less, the thermal propagation rate is improved.

That is, as compared with Comparative Example 1, which indicates a case in which no refractory assembly or refractory member is provided, the thermal propagation rate is improved in Embodiments 1 to 3 when the volume of the refractory member 271 relative to the volume of the refractory space 274 is 48% or more.

In another example, when a volume of the refractory member 271 is 65% or more and 100% or less, or 88% or more and 100% or less, the thermal propagation rate is further improved. This is in consideration of vibration or noise.

Also, a volume of the refractory assembly 270 relative to a volume of one of the plurality of separated spaces 2889 may be 77% or more and 100% or less.

For example, referring to FIGS. 4 and 5 and Table 1, a length of the refractory assembly 270 relative to the length P2 is 82% or more and 100% or less. A length of the refractory assembly 270 relative to the length P1 is 93% or more and 100% or less, and a length of the refractory assembly 270 relative to the length P3 is 98% or more and 100% or less.

For the experiments of the embodiments and comparative examples mentioned in Table 1, when the battery cell 110 is heated by attaching a heating plate to the single battery cell 110 accommodated in the accommodation case 210, the battery cell 110 is ignited using a heating plate having an electricity consumption of about 150 W (watts) to 700 W, and the heating is terminated when the battery cell 110 is ignited. Thereafter, a heat transfer rate is measured.

The specific experimental method is based on GB 38031-2020, which is a Chinese National Standard (GB) for Electric Vehicles Traction Battery Safety Requirements.

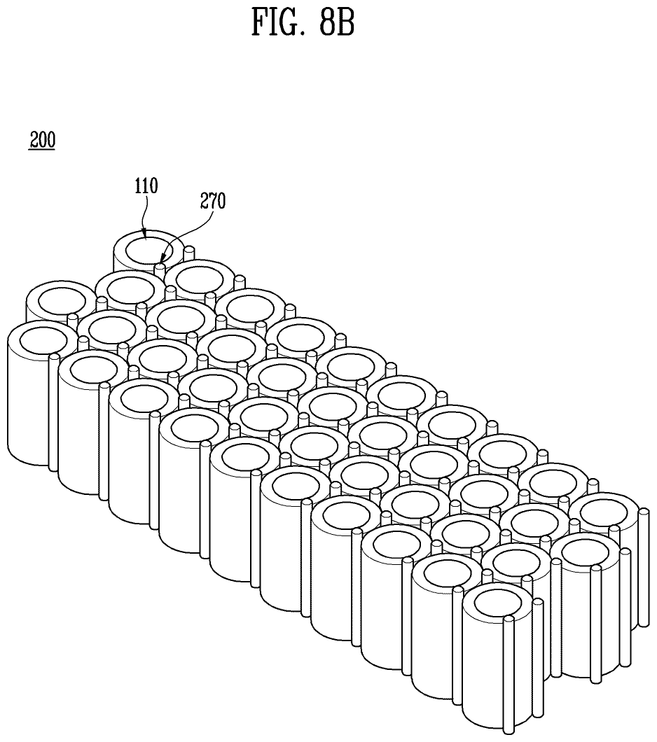

FIG. 8A is a view illustrating a portion of another example of the battery assembly 200 according to the present disclosure. FIG. 8B is a view illustrating a portion of another example of the battery assembly 200 according to the present disclosure.

Referring to FIG. 8A, the battery cells included in the battery assembly 200 according to the present disclosure may be prismatic battery cells. That is, the battery assembly 200 according to the present disclosure may include a plurality of battery cells 110 stacked in a predetermined direction and a refractory assembly 270 disposed between the plurality of battery cells 110. For convenience, the accommodation case accommodating the plurality of battery cells 110 and the refractory assembly 270 is omitted.

On the other hand, terminals of the prismatic battery cells 110 may be disposed at an upper portions of the prismatic battery cells 110 along the height direction of the accommodation case. Accordingly, a busbar for electrically connecting the plurality of battery cells 110 may be disposed on the upper portion of the plurality of battery cells 110.

The plurality of battery cells 110 may include a refractory assembly 270 disposed between the plurality of battery cells 110. For convenience, the accommodation case accommodating the plurality of battery cells 110 and the refractory assembly 270 is omitted.

Referring to FIG. 8B, the battery cells included in the battery assembly 200 according to the present disclosure may be cylindrical battery cells. That is, the battery assembly 200 according to the present disclosure may include a plurality of battery cells 110, an accommodation case (not shown) accommodating the plurality of battery cells 110, and a refractory assembly 270 disposed between the plurality of battery cells 110 or between the plurality of battery cells 110 and the accommodation case 210.

In the case of cylindrical battery cells 110, unlike prismatic or pouch-shaped battery cells 110, an empty space may also be formed between respective cylindrical battery cells 110 into which the refractory assembly 270 may be inserted. Thus, the refractory assembly 270 may be inserted even into the empty space.

First, according to one embodiment of the present disclosure, the object of the present disclosure is to mitigate or prevent the thermal propagation (TP) of hot gases generated from the battery cell in which the thermal runaway occurs among one or more battery cells of the battery assembly, such as a battery module or a battery pack, to the neighboring battery cells.

Second, according to another embodiment of the present disclosure, the object of the present disclosure is to vent the hot gases generated from the battery cell in which the thermal runaway occurs through the intended path.

Third, according to another embodiment of the present disclosure, the object of the present disclosure is to increase the thermal stability of the battery assembly by increasing the heat resistance or fire resistance thereof.

The above described is merely an example of the application of the principles of the present disclosure, and other configurations may be included without departing from the scope of the present invention.

What is claimed is:

1. A battery assembly comprising:
a plurality of battery cells stacked in a stacking direction;
an accommodation case configured to accommodate the plurality of battery cells;
an insertion space defined between the plurality of battery cells and the accommodation case; and
a refractory assembly comprising a refractory member comprising a refractory material and an exterior member configured to define a refractory space that accommodates the refractory member therein, the refractory assembly being disposed in the insertion space,
wherein a volume of the refractory member relative to a volume of the refractory space is equal to or greater than 48% and equal to or less than 100%.

2. The battery assembly of claim 1, wherein each of the plurality of battery cells comprises:
a main body configured to accommodate an electrode assembly; and
a lead tab having at least a portion disposed at the outside of the main body and electrically connected to the electrode assembly, and
the insertion space is separated into a separated spaces by respective lead tabs of the plurality of battery cells.

3. The battery assembly of claim 2, wherein the refractory assembly is provided in plurality, and
each of the plurality of refractory assemblies is disposed in at least some of the plurality of separated spaces.

4. The battery assembly of claim 2, further comprising a busbar assembly electrically connected to the respective lead tabs and configured to support the plurality of battery cells,
wherein the insertion space is defined between respective main bodies of the plurality of battery cells and the busbar assembly.

5. The battery assembly of claim 4, wherein the busbar assembly further comprises:
a busbar electrically connected to the plurality of battery cells; and
a busbar frame which is disposed between the busbar and the plurality of battery cells to support the busbar and into which respective lead tabs of the plurality of battery cells are inserted, respectively.

6. The battery assembly of claim 5, wherein the plurality of separated spaces are defined by the busbar frame, respective main bodies, and respective lead tabs.

7. The battery assembly of claim 6, wherein a volume of the refractory assembly relative to a volume of any one of the plurality of separated spaces is equal to or greater than 77% and equal to or less than 100%.

8. The battery assembly of claim 2, wherein the insertion space comprises:
a first insertion space defined between the plurality of battery cells and one side surface of the accommodation case, which extends along the stacking direction; and
a second insertion space defined between the plurality of battery cells and the other side surface of the accommodation case, which faces the one side surface of the accommodation case, and
the refractory assembly is disposed in at least one of the first insertion space or the second insertion space.

9. The battery assembly of claim 8, wherein each of the lead tabs comprises:
a first lead tab configured to separate the first insertion space; and
a second lead tab configured to separate the second insertion space, and
the first insertion space and the second insertion space are separated into a plurality of separated spaces by the first lead tap and the second lead tap, respectively.

10. The battery assembly of claim 1, wherein the exterior member begins to melt when a predetermined temperature is reached.

11. The battery assembly of claim 10, wherein the predetermined temperature is lower than a melting point of the refractory member.

12. The battery assembly of claim 1, wherein the refractory member comprises silicon dioxide (SiO₂).

13. The battery assembly of claim 1, wherein at least one end of both ends of the exterior member is tapered.

14. The battery assembly of claim 1, wherein the exterior member comprises:
a body having a columnar shape; and
a first end and a second end connected to upper and lower ends of the body along a height direction of the accommodation case to define the refractory space with the body, and
the first end is gradually tapered in a direction away from the body.

15. The battery assembly of claim 14, wherein the accommodation case further comprises a body bottom surface that is a bottom surface of the accommodation space, and
the second end comprises a flat surface parallel to the body bottom surface.

16. The battery assembly of claim 1, wherein the refractory member comprises a plurality of refractory particles.

17. The battery assembly of claim 16, wherein the refractory member further comprises a plurality of air gaps between the plurality of refractory particles.

18. The battery assembly of claim 16, wherein each of the plurality of refractory particles is in the form of a granular material.
